(19) United States
(12) Patent Application Publication
(10) Pub. No.: US 2012/0183934 A1
(43) Pub. Date: Jul. 19, 2012

(54) METHOD AND APPARATUS FOR MEASURING AND PRESENTING EATING RATE

(76) Inventors: Per Södersten, Stockholm (SE); Cecilia Bergh, Stockholm (SE); Motjaba Zandian, Stockholm (SE)

(21) Appl. No.: 13/498,737

(22) PCT Filed: Sep. 28, 2010
(86) PCT No.: PCT/SE2010/000233

§ 371 Date: Mar. 28, 2012

(30) Foreign Application Priority Data
Sep. 28, 2009 (SE) 0901245-1

(51) Int. Cl. G09B 19/00

(52) U.S. Cl. 434/127

(57) ABSTRACT

The invention regards a medical apparatus made up of at least two devices (30, 32) adapted to measure eating rate utilized to teach persons to eat according to a predetermined graphic eating curve (10, 24) displayed on a screen, and a method therefore. There are means in a memory automatically calculating equations for predetermined eating curves (10, 24) based on data obtained from a cumulative food intake in a control meal through an introductory curve followed by training curves. The cumulative food intake is fitted to a quadratic equation y=ax²+bx+c, where the parameter y represents food intake, and represents a change in the slope of the curve over time x, b represents a constant slope of the curve over time, the initial rate of eating, and c represents food intake at the start of a meal, whereby the introductory curve has the same properties as the cumulative food intake obtained in a control meal.

### TECHNICAL FIELD

The present invention pertains to a medical apparatus made up of at least two devices adapted to measure eating rate utilized to teach persons to eat according to a predetermined graphic eating curve displayed on a screen, and a method therefore.

### BACKGROUND ART

An apparatus named “Mandometer®” has been developed at the Section of Applied Neuroendocrinology and Mandometer® Clinic, Karolinska Institutet, Stockholm, Sweden. It consists of a scale that is connected to a computer. A plate is placed on the scale, the patient puts a measured portion of food determined by a therapist on the plate and the computer records and stores the weight loss from the plate while the patient eats.

This yields a curve of eating rate which is visible to the patient on the computer screen during a meal and can be compared to a pre-set eating curve on screen. At regular intervals, a rating scale appears on the monitor of the computer and the patient rates her/his level of fullness/satiety. The scale has numerical values from 0 (no satiety) to 100 (maximum satiety). As the patients rate their satiety a dot appears on the screen and yields a curve of the development of satiety (fullness). The patients can thus compare their development of fullness to a “normal” fullness curve again pre-set on screen. During “Mandometer®-training” the patient gradually adopts a more normal pattern of eating and satiety by following the training curves, which are displayed on the monitor during the meal. These methods were originally developed for treating eating disorders such as anorexia and bulimia nervosa: they have been evaluated in a randomized controlled trial with an estimated rate of remission of 75%. It was suggested many years ago that most obese people eat at a high constant rate, and in a pilot study on obese adolescents using Mandometer® this observation was confirmed.

The apparatus Mandometer® is patented in several countries for instance in the U.S. Pat. No. 5,817,006 to Bergh et al.

### SUMMARY OF THE INVENTION

The present invention has as one aim to provide a medical apparatus measuring eating rate utilized to teach persons to eat in a normal eating rate in order to aid them to feel full after an intake of a meal, and still gaining or losing weight in a controlled scientific environment. Resent scientific studies have shown that a descending rate of eating prevent persons to overeat by eating in a correct manor which has clinical implication for obese to lose weight.

As such the present invention sets forth a medical apparatus made up of at least two devices adapted to measure eating rate utilized to teach persons to eat according to a predetermined graphic eating curve displayed on a screen. Hereby, the invention comprises:

a device with a screen storing the predetermined graphic eating curve in a memory, the first device having at least one of remote near field radiation and wire capabilities for communication with a related second device;

the related second device scale is adapted to communicate with the first device, having at least one of remote near field radiation and wire communication capabilities adapted to the first device;

weighing food on the scale in a measurement session of a length of time, and transmitting the food weight to the first device through the communication capabilities when food is removed from the scale by a person eating the food, and through means of software residing in the first device storing the amount of food removed during a session in the memory, displaying the weight of food removed as a measurement point on the screen when it is removed from the scale to make up a real time graphic eating curve to be compared with the predetermined eating curve; and further comprising:

means in the memory automatically calculating equations for predetermined eating curves based on data obtained from a cumulative food intake in a control meal through an introductory curve followed by training curves, whereby the cumulative food intake is fitted to a quadratic equation y=ax²+bx+c, where the parameter y represents food intake, a represents a change in the slope of the curve over time, b represents a constant slope of the curve over time, the initial rate of eating, and c represents food intake at the start of a meal, whereby the introductory curve has the same properties as the cumulative food intake obtained in a control meal.

In one preferred embodiment of the present invention, the equation for each training curve is based on a decelerated eating style characterized by a being <−1, or a linear type of the equation characterized by a in the equation being between 0≧a>1, whereby a normal initial eating rate constitutes 48 gram/minutes, and a normal food intake is 320-360 grams and a normal meal duration is 12-15 minutes, thus a pseudo code for the rate of eating is comprised by:

y=ax²+bx+c

Food intake=If y>720 Then 600 Else y−70
Initial eating rate=b−(¼ (b−48))

$$Deceleration or linear rate = \frac{y - bx}{{x}^{2}}$$

Another embodiment comprises that the scale and the first device is integrated into a single device.

A further embodiment comprises that the scale has its scale measuring surface formed as a bowl or plate to be served food on.

A still further embodiment provides that the scale is pocket portable.

Yet one embodiment provides that the predetermined graphic curve describes a non linear eating behaviour, which is found through science studies to mimic an eating behaviour that is favourable to human beings.

Yet another embodiment comprises that the predetermined graphic curve describes a linear rate of eating behaviour.

Yet a still further embodiment provides that a predetermined graphic curve of satiety is displayed on the screen, to be compared with satiety ratings made during pre-set time intervals on the screen by a person utilizing the device.

Furthermore, the present invention sets forth a method adapted to a medical apparatus made up of at least two devices adapted to measure eating rate utilized to teach persons to eat according to a predetermined graphic eating curve displayed on a screen. The invention method thus comprises:

storing the predetermined graphic eating curve in a memory of a device with a screen, the first device having at least one of remote near field radiation and wire capabilities for communication with a related second device;

adapting a scale to communicate with the first device through the related second device, having at least one of remote near field radiation and wire communication capabilities adapted to the first device;

weighing food on the scale in a measurement session of a length of time, and transmitting the food weight to the first device through the communication capabilities when food is removed from the scale by a person eating the food, and through means of software residing in the first device storing the amount of food removed during a session in the memory, displaying the weight of food removed as a measurement point on the screen when it is removed from the scale to make up a real time graphic eating curve to be compared with the predetermined eating curve; and further comprising:

automatically calculating equations through means in the memory for predetermined eating curves based on data obtained from a cumulative food intake in a control meal through an introductory curve followed by training curves, whereby the cumulative food intake is fitted to a quadratic equation y=ax²+bx+c, where the parameter y represents food intake, a represents a change in the slope of the curve over time, b represents a constant slope of the curve over time, the initial rate of eating, and c represents food intake at the start of a meal, whereby the introductory curve has the same properties as the cumulative food intake obtained in control a meal.

The present invention method also adheres to the attached dependent claims of the above mentioned apparatus.

### BRIEF DESCRIPTION OF THE DRAWINGS

Henceforth reference is had to the attached figures in the accompanying text of the description for a better understanding of the present invention with its embodiments and given examples, wherein:

FIG. 1 is illustrating graphics for a linear eating behaviour;

FIG. 2 is illustrating graphics for a descending eating behaviour; and

FIG. 3 is schematically illustrating an embodiment of an apparatus with cellular radio capabilities in contact with a scale through near field radiation communication in accordance with the present invention.

### DETAILED DESCRIPTION OF PREFERRED EMBODIMENTS

The present invention is related to a medical measuring apparatus consisting of a first device such as cellular phones, PDA's, computers, PC, Laptop, Iphone®, androids, and like devices. A second device is in the form of a scale for measuring every portion of food eaten by a person from a plate or bowl or the like placed on the scale during a meal This apparatus is utilized in teaching persons suffering from anorexia nervosa, bulimia nervosa, obesity, other gastrointestinal problems and persons that would like to have control of their intake of food to keep them fit.

A study regarding obesity among children and youth was conducted at Bristol Royal Hospital for Children in England utilizing the “Mandometer®” (prior art), which was developed at the Section of Applied Neuroendocrinology and Mandometer® Clinic, Karolinska Institutet, Stockholm, Sweden. It consists of a scale that is connected to a computer. A plate is placed on the scale; the patient puts a measured portion of food determined by a therapist on the plate and the computer records and stores the weight loss from the plate while the patient eats.

This yields a curve of eating rate which is visible to the patient on the computer screen during their meal and can be compared to a pre-set eating curve on screen. At regular intervals, a rating scale appears on the monitor of the computer and the patient rates her/his level of fullness. The scale has for instance numerical values from 0 (no satiety) to 100 (maximum satiety). As patients rate their satiety a dot appears on the screen and yields a curve of the development of satiety (fullness). The patient can thus compare their development of fullness to a “normal” fullness curve again pre-set on screen. During “Mandometer®-training” the patient gradually adopts a more normal pattern of eating and satiety by following the training curves, which are displayed on the monitor during the meal. These methods were originally developed for treating eating disorders such as anorexia and bulimia nervosa.

This study came to a further improved possible outcome, namely that Mandometer® curves for practicing eating can have a decelerated shape, as this pattern may protect individuals for overeating. Analysis of the average speed of eating, as used here, neglects minute-to-minute changes during the meal, which may explain the absence of a statistically significant effect on this simplified measure of speed of eating.

The findings of decelerated eating have been undergoing further scientific tests and analysis emanating in the following scientific papers “Decelerated and linear eaters: Effect of eating rate on food intake and satiety Modjtaba Zandian a, Ioannis Ioakimidis a, Cecilia Bergh a, Ulf Brodin a,b, Per Södersten a, published by Elsevier, Physiology & Behavior, received Mar. 18, 2008, received in revised form 2 Oct. 2, 2008, and accepted Oct. 9, 2008:

a) Karolinska Institutet, Section of Applied Neuroendocrinology, NVS, and Mandometer and Mandolean Clinics, AB Mando, Novum, S-141 57 Huddinge, Sweden

b) Karolinska Institutet, LIME, Section of Medical Statistics, S-171 77 Stockholm, Sweden.

Another published paper is “Linear eaters turned decelerated: Reduction of a risk for disordered eating?” to Modjtaba Zandian, Ioannis Ioakimidis, Cecilia Bergh, Per Södersten, published by Elsevier, Physiology & Behavior, received Jul. 4, 2008, revised Nov. 14, 2008, and accepted Nov. 25, 2008.

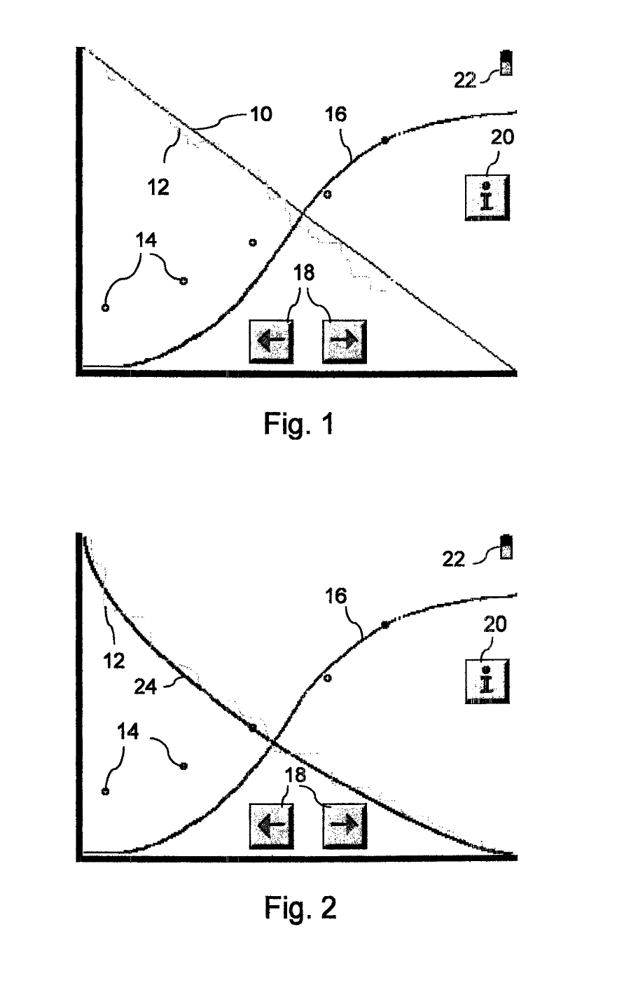

Henceforth, an embodiment of an apparatus utilized for the descended eating rate scientific findings is described as an example out of many possible apparatus. it is appreciated that the equation utilized in this invention also can be fitted to non decelerating linear eating/linear eating behaviors such as described through FIG. 1.

In FIG. 1 graphics are illustrated for linear eating, which was the prior standard for measuring eating rate and satiety utilizing the Mandometer® measuring device or the apparatus of the present invention. Hereby, a predetermined linear eating rate curve 10 is depicted together with an actual real time eating curve 12 recorded from a person utilizing the Mandometer® measuring device. The curve 12 should as much as possible match the linear curve 10 to achieve an acceptable normal eating rate, which can aid the person eating to gain or lose weight depending on the persons physical condition.

The dots 14 show how the person eating has rated the satiety during predetermined time periods/intervals, which if connected with a line make up a curve itself illustrating the satiety/fullness of the person eating. Moreover, the FIG. 1 depicts a predetermined sigmoid curve 16 mimicking a normal satiety rating to be compared with the satiety ratings 14 made by the person eating. Buttons 18 are touch buttons utilized to browse between different stored meals in the device with cellular capabilities in accordance with an embodiment of the present invention. Also shown in FIG. 1 is an information button 20, which if pushed for instance shows the amount of food eaten during a session and the duration of the session. Also shown is an icon for the battery charge 22 of the cellular device.

FIG. 2 illustrates similar curves and functions as in FIG. 1, but with the difference that a curve 24 shows a descended eating rate according to recent scientific research results, which better mimics an average persons eating rate.

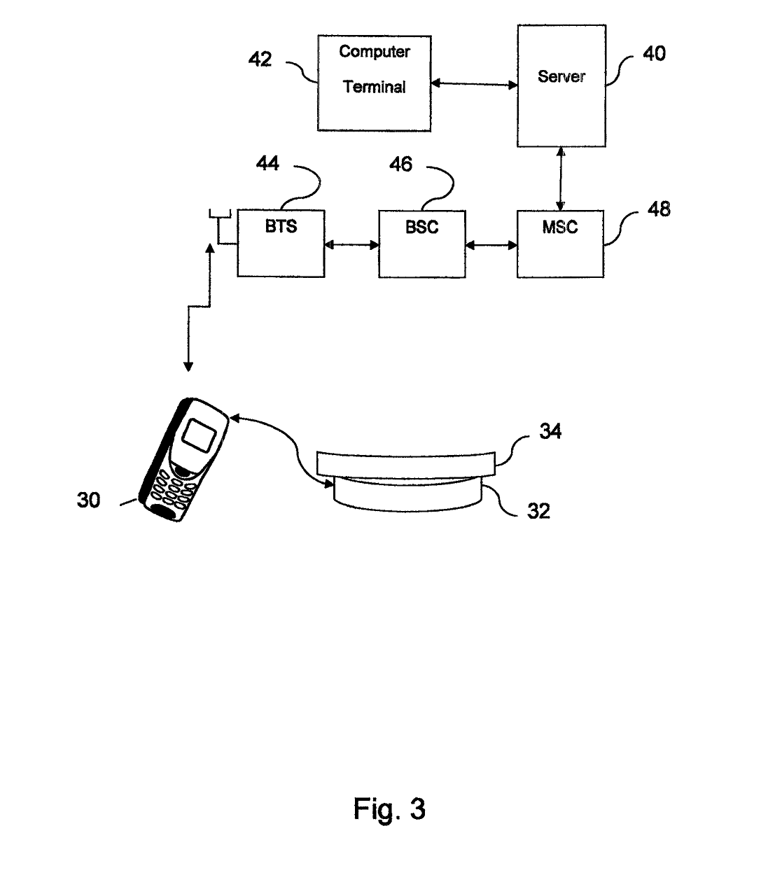

FIG. 3 schematically depicts an embodiment out of many possible of the apparatus according to the present invention by comprising a cellular phone 30 with a display screen of any known constitution such as having a conventional keypad or a touch screen. Moreover the apparatus comprises a scale 32 of preferably a small pocket size. It also shows a plate or bowl 34 utilized to put food on when a person is eating. The cellular device 30 and scale 32 communicate with each other through near field radiation such as for instance Bluetooth or Infrared (IR) or the like, schematically depicted through the double arrow.

A communication between the scale and the cellular device 30 transmits data of how much food the person eating removes from the plate 34 in eating intervals, and the eating rate. The person also rates the satiety 14 in predetermined time intervals on the cellular device screen. Hence, the curves for eating rate 12 and satiety 14 according to Fig. and FIG. 2 are displayed so that a person eating from the plate 34 can adapt its eating rate to the curves 10, 24 for a predetermined eating rate and/or compare its satiety to the curves 16 showing satiety.

Moreover, a software means is utilized to transmit the stored session through the first device 30 cellular phone capabilities to a remote server 40 connected with a computer terminal 42 for registration of curves for eating rate 12. A means in the server is able to send adapting instructions to the first device 30 regarding what predetermined graphic eating curve 10, 24 to be utilized from arbitrary geographical places due to previous registrations of real time graphic eating curves in order to adapt the registered eating behaviour of a person utilizing the system apparatus of the present invention.

The cellular phone 30 and server 40 with terminal 32 communicate through known techniques by for instance a base station transceiver (BST) 44 via a base station controller (BSC) 46 and a mobile services switch 48. The communication between devices 40, 42, 44, 46, 48 and cellular phone 30 with scale 32 is depicted through double pointed arrows in FIG. 3.

Persons utilizing the present invention apparatus could in a worst case scenario be in immediate need of medical care, thus it is provided in one embodiment that the location of a person utilizing the apparatus can be tracked through for instance a global positioning system (GPS) residing in the cellular phone 30. Another possibility of tracking the person could be achieved by utilizing the signalling system of the phone 30, which includes wireless mobile location data in the call signal. Wireless mobile location data pin points the real time geographical location of the phone 30, and in most cases also where the user of the phone 30 is located.

Hence, FIG. 3 presents a possible embodiment of the present invention medical apparatus 30, 32 made up of at least two devices adapted to measure eating rate 12 utilized to teach persons to eat according to a predetermined graphic eating curve 10, 24 displayed on a screen. Hereby it comprises a device 30 with a screen storing the predetermined graphic eating curve 10, 24 in a memory. The first device 30 has at least one of remote near field radiation and wire capabilities for communication with a related second device 32. A wire connection for instance an USB, VGA or other known connection can be utilized when the first device for instance is a Laptop or other known computer.

The related second device 32 scale is adapted to communicate with the first device 30, and has at least one of remote near field radiation and wire communication capabilities adapted to the first device 30. A weighing of food on the scale 32 in a measurement session of a length of time is conducted, and the food weight is transmitted to the first device 30 through the communication capabilities when food is removed from the scale by a person eating the food. This is accomplished through means of software residing in the first device 30 storing the amount of food removed during a session in the memory, and which displays the weight of food removed as a measurement point on the screen when it is removed from the scale to make up a real time graphic eating curve 12 to be compared with the predetermined eating curve 10, 24.

Moreover, the present invention comprises means, for instance software means, in the memory automatically calculating equations for predetermined eating curves 10, 24 based on data obtained from a cumulative food intake in a control meal through an introductory curve followed by training curves. The cumulative food intake is fitted to a quadratic equation y=ax²+bx+c, where the parameter y represents food intake, and represents a change in the slope of the curve over time represented by the parameter x, b represents a constant slope of the curve over time, the initial rate of eating, and c represents food intake at the start of a meal, whereby the introductory curve has the same properties as the cumulative food intake obtained in control a meal.

In one preferred embodiment of the present invention, the equation for each training curve is based on a decelerated eating style characterized by a being <−1, or a linear type of the equation characterized by a in the equation being between 0≧a >−1, whereby a normal initial eating rate constitutes 48 gram/minutes, and a normal food intake is 320-360 grams and a normal meal duration is 12-15 minutes, thus a pseudo code for the rate of eating is comprised by:

y=ax²+bx+c

Food intake=If y>720 Then 600 Else y−70
Initial eating rate=b−(¼ (b−48))

$$\begin{matrix}Deceleration or linear rate \\ depending on the rate of a\end{matrix} = \frac{y - bx}{{x}^{2}}$$

Another embodiment comprises that the scale and the first device are integrated into a single device. A further embodiment comprises that the scale has its scale measuring surface formed as a bowl or plate to be served food on.

A still further embodiment provides that the scale is pocket portable. One embodiment provides that the predetermined graphic curve describes a non linear eating behaviour, which is found through science studies to mimic an eating behaviour that is favourable to human beings.

Another embodiment comprises that the predetermined graphic curve describes a linear rate of eating behaviour. Yet a still further embodiment provides that a predetermined graphic curve of satiety is displayed on the screen, to be compared with satiety ratings made during pre-set time intervals on the screen by a person utilizing the device.

Furthermore, the present invention includes a method adapted to a medical apparatus made up of at least two devices adapted to measure eating rate utilized to teach persons to eat according to a predetermined graphic eating curve displayed on a screen. The invention method thus comprises storing the predetermined graphic eating curve in a memory of a device with a screen. The first device has at least one of remote near field radiation and wire capabilities for communication with a related second device. A scale is adapted to communicate with the first device through the related second device, which has at least one of remote near field radiation and wire communication capabilities adapted to the first device. Food is weighed on the scale in a measurement session of a length of time, and the food weight is transmitted to the first device through the communication capabilities, when food is removed from the scale by a person eating the food. This is accomplished through means of software residing in the first device storing the amount of food removed during a session in the memory, and displaying the weight of food removed as a measurement point on the screen when it is removed from the scale to make up a real time graphic eating curve to be compared with the predetermined eating curve.

Moreover, the present method comprises an automatic calculation of equations through means in the memory for predetermined eating curves based on data obtained from a cumulative food intake in a control meal through an introductory curve followed by training curves. The cumulative food intake is fitted to a quadratic equation y=ax²+bx+c, where the parameter y represents food intake, a represents a change in the slope of the curve over time x, b represents a constant slope of the curve over time, the initial rate of eating, and c represents food intake at the start of a meal, whereby the introductory curve has the same properties as the cumulative food intake obtained in control a meal.

The present invention is not restricted to the examples and given embodiments presented above. A person skilled in the art is able to derive further possible embodiments by the attached set of claims.

1. A medical apparatus made up of at least two devices adapted to measure eating rate utilized to teach persons to eat according to a predetermined graphic eating curve displayed on a screen, characterized in that it comprises:
a device with a screen storing said predetermined graphic eating curve in a memory, said first device having at least one of remote near field radiation and wire capabilities for communication with a related second device;
said related second device scale adapted to communicate with said first device, having at least one of remote near field radiation and wire communication capabilities adapted to said first device;
weighing food on said scale in a measurement session of a length of time, and transmitting the food weight to said first device through said communication capabilities when food is removed from said scale by a person eating the food, and through means of software residing in said first device storing the amount of food removed during a session in said memory, displaying the weight of food removed as a measurement point on said screen when it is removed from said scale to make up a real time graphic eating curve to be compared with said predetermined eating curve; and further comprising:
means in said memory automatically calculating equations for predetermined eating curves based on data obtained from a cumulative food intake in a control meal through an introductory curve followed by training curves, whereby the cumulative food intake is fitted to a quadratic equation y=ax²+bx+c, where the parameter y represents food intake, a represents a change in the slope of the curve over time, b represents a constant slope of the curve over time, the initial rate of eating, and c represents food intake at the start of a meal, whereby the introductory curve has the same properties as the cumulative food intake obtained in control a meal.

2. An apparatus according to claim 1, wherein the equation for each training curve is based on a decelerated eating style characterized by a being <−1, or a linear type of the equation characterized by a in the equation being between 0≧a>−1, whereby a normal initial eating rate constitutes 48 gram/minutes, and a normal food intake is 320-360 grams and a normal meal duration is 12-15minutes, thus a pseudo code for the rate of eating is comprised by:
y=ax²+bx+c
Food intake=If y>720 Then 600 Else y−70
Initial eating rate=b−(¼ (b−48))
$$Deceleration or linear rate = \frac{y - bx}{{x}^{2}}$$

3. An apparatus according to claim 1, wherein said scale and said first device are integrated into a single device.

4. An apparatus according to claim 1, wherein said scale has its scale measuring surface formed as a bowl or plate to be served food on.

5. An apparatus according to claim 1, wherein said scale is pocket portable.

6. An apparatus according to claim 1, wherein said predetermined graphic curve describes a non linear eating behaviour, which is found through science studies to mimic an eating behaviour that is favourable to human beings.

7. An apparatus according to claim 1, wherein said predetermined graphic curve describes a linear rate of eating behaviour.

8. An apparatus according to claim 1, wherein a predetermined graphic curve of satiety is displayed on said screen, to be compared with satiety ratings made during pre-set time intervals on said screen by a person utilizing said device.

9. A method adapted to a medical apparatus made up of at least two devices adapted to measure eating rate utilized to teach persons to eat according to a predetermined graphic eating curve displayed on a screen, characterized in that it comprises:
storing said predetermined graphic eating curve in a memory of a device with a screen, said first device having at least one of remote near field radiation and wire capabilities for communication with a related second device;
adapting a scale to communicate with said first device through said related second device, having at least one of remote near field radiation and wire communication capabilities adapted to said first device;
weighing food on said scale in a measurement session of a length of time, and transmitting the food weight to said first device through said communication capabilities when food is removed from said scale by a person eating the food, and through means of software residing in said first device storing the amount of food removed during a session in said memory, displaying the weight of food removed as a measurement point on said screen when it is removed from said scale to make up a real time graphic eating curve to be compared with said predetermined eating curve; and further comprising:
automatically calculating equations through means in said memory for predetermined eating curves based on data obtained from a cumulative food intake in a control meal through an introductory curve followed by training curves, whereby the cumulative food intake is fitted to a quadratic equation y=ax²+bx+c, where the parameter y represents food intake, a represents a change in the slope of the curve over time, b represents a constant slope of the curve over time, the initial rate of eating, and c represents food intake at the start of a meal, whereby the introductory curve has the same properties as the cumulative food intake obtained in control a meal.

10. A method according to claim 9, wherein the equation for each training curve is based on a decelerated eating style characterized by a being <−1, or a linear type of the equation characterized by a in the equation being between 0≧a>−1, whereby a normal initial eating rate constitutes 48 gram/minutes, and a normal food intake is 320-360 grams and a normal meal duration is 12-15 minutes, thus a pseudo code for the rate of eating is comprised by:
y=ax²+bx+c
Food intake=If y>720 Then 600 Else y−70
Initial eating rate=b−(¼ (b−48))
$$Deceleration or linear rate = \frac{y - bx}{{x}^{2}}$$

11. A method according to claim 9, wherein said scale and said first device are integrated into a single device.

12. A method according to claim 9, wherein said scale has its scale measuring surface formed as a bowl or plate to be served food on.

13. A method according to claim 9, wherein said scale is pocket portable.

14. A method according to claim 9, wherein said predetermined graphic curve describes a non linear eating behaviour, which is found through science studies to mimic an eating behaviour that is favourable to human beings.

15. A method according to claim 9, wherein said predetermined graphic curve describes a linear rate of eating behaviour.

16. A method according to claim 9, wherein a predetermined graphic curve of satiety is displayed on said screen, to be compared with satiety ratings made during pre-set time intervals on said screen by a person utilizing said apparatus.
